(19) United States
(12) Patent Application Publication
(10) Pub. No.: US 2005/0101277 A1
(43) Pub. Date: May 12, 2005

(54) Gain control for interference cancellation

(76) Inventors: Anand P. Narayan, Boulder, CO (US); Eric S. Olson, Milwaukee, WI (US)

Correspondence Address: TENSORCOMM, INC., 1490 W. 121ST AVE., SUITE 105, WESTMINISTER, CO, 80234, US

(21) Appl. No.: 11/012,817

(22) Filed: Dec. 14, 2004

Related U.S. Application Data
(63) Continuation-in-part of application No. 09/988,219, filed on Nov. 19, 2001, now Pat. No. 6,856,945.
(63) Continuation-in-part of application No. 10/773,777, filed on Feb. 6, 2004.
(63) Continuation-in-part of application No. 10/669,954, filed on Sep. 23, 2003, now abandoned.
(63) Continuation-in-part of application No. 10/686,828, filed on Oct. 15, 2003.
(63) Continuation-in-part of application No. 10/686,829, filed on Oct. 15, 2003.
(63) Continuation-in-part of application No. 10/699,360, filed on Oct. 31, 2003.
(63) Continuation-in-part of application No. 10/294,834, filed on Nov. 15, 2002.
(63) Continuation-in-part of application No. 10/686,359, filed on Oct. 15, 2003.
(63) Continuation-in-part of application No. 10/763,346, filed on Jan. 23, 2004.

(51) Int. Cl. H04B 1/10; H04B 1/06; H04B 7/00

(52) U.S. Cl. 455/232.1; 455/219

(57) ABSTRACT

Systems and methods for adjusting amplitude of an input signal through the application of a gain term are presented. In one embodiment, the gain controller comprises a scaling element that scales the overall signal energy after interference cancellation is performed. This scaling may compensate for overall signal energy reduction resulting from interference cancellation that improves the SNR of the signals of interest. Since prior art receivers typically adjust signal amplitude at the front-end, the gain controller may adjust the amplitude of an interference-canceled signal to a level that is substantially comparable to the level after front-end scaling. The gain controller also comprises a receiving element configured for receiving either an output canceled signal or an uncanceled received signal as an input. For example, the gain controller may receive an interference-canceled signal output from a Coded Signal Processing Engine or a signal with no interfering components removed.

### CROSS REFERENCE TO RELATED APPLICATIONS

This application is a continuation-in-part of commonly owned and co pending U.S. patent application Ser. No. 10/773,777 (filed Feb. 06, 2004; the “'777 application”), Ser. No. 10/699,954 (filed Sep. 23, 2003; the “'954 application”), Ser. No. 10/686,828 (filed Oct. 15, 2003; the “'828 application”), Ser. No. 10/686,829 (filed Oct. 15, 2003; the “'829 application”), Ser. No. 10/699,360 (filed Oct. 31, 2003; the “'360 application”), Ser. No. 10/294,834 (filed Nov. 15, 2002; the “834 application”), Ser. No. 10/686,359 (filed Oct. 15, 2003; the “359 application”) Ser. No. 10/763,346 (filed Jan. 23, 2004; the “'346 application”), TCOM0019 (filed Sep. 7, 2004; the “'TCOM19 application”), TCOM0024 (filed, 2004; the “'TCOM0024 application”) and TCOM0020 (filed Sep. 7, 2004; the “'TCOM0020 application”), which are all hereby incorporated by reference. This application is also related to Ser. No. 09/988,219 (filed Nov. 19, 2001; the “'219 application”) and to Ser. No. 10/247,836 (filed Sep. 20, 2002; the “'836 application”), which are each hereby incorporated by reference.

### BACKGROUND

1. Field of the Invention

The invention generally relates to the field of communications. More specifically the invention relates to gain control for use in coded signal communications, such as Code Division Multiple Access (“CDMA”) communications.

2. Discussion of the Related Art

In CDMA communication, coded signals are used to communicate between devices. Some typical CDMA communication systems use combinations of “spreading codes” and “covering codes” to encode signals. These encoded digital signals are used to convey digital voice, data and/or other forms of digital communication. As used herein spreading codes are pseudorandom number, or pseudo-noise, (“PN”) sequence codes and are known to those skilled in the art. Covering codes are also known those skilled in the art.

A spreading code encodes a data signal by applying a noise-like code sequence to the data at a rate faster than that of the data. Namely, the spreading code is applied to the data such that there are multiple “chips” of the code for any given element of data. Such an application of the spreading code is commonly referred to as direct sequence spreading of the data. A short code is an example of a spreading code. Chips and their associated chip rates are known to those skilled in the art.

A covering code further encodes the signal to provide “channelization” for a signal. For example, each unique covering code as it is applied to a spread signal provides a unique communication channel for the spread signal. Channelization allows a signal to be divided into a number of individual communication channels that may be either shared or assigned to specific users. Covering codes typically include families of codes that are either orthogonal (e.g., Walsh codes) or substantially orthogonal (e.g. Quasi Orthogonal Function codes, or “QOF” codes).

While the above-mentioned codes can be used to differentiate signals, interference from unwanted signals is a persistent problem in CDMA telephony communications. Interference degrades signal detection, tracking and demodulation capabilities of a receiver by hindering the recovery of a selected signal (i.e., a signal of interest, “SOI”). For example, interference can be the result of receiving one or more unwanted signals simultaneously with a selected signal. These interfering signals increase the total energy of the received signal, but decrease the Signal to Noise Ratio (“SNR”) of the selected signal.

The interfering signals can be coded signals having properties that are similar to that of the selected signal. Because of code similarities and associated signal energy, the coded signals often have a tendency to interfere with one another and disrupt the recovery of the selected signal. The lack of orthogonality of the received signals results in “leakage” from one signal into another. Examples of such interference include “cross-channel” interference and “co-channel” interference.

Co-channel interference may include multipath interference from the same transmitter, wherein a transmitted signal takes separate, unique paths that causes one path (e.g., an interfering signal path) and another path (e.g., a selected signal path) to differentially arrive at a receiver, thereby hindering processing of the selected signal path. Cross-channel interference may include interference caused by signal paths emanating from other transmitters, thereby hindering the processing of the selected signal path. Such interference can corrupt data and interfere with signal recovery as long as it is present in any substantial form.

Interference cancellation, such as that described in the '360, '828, '777 and TCOM0020 applications, substantially removes selected cross-channel interference and/or co-channel interference from a received signal. This interference cancellation increases the SNR of a selected signal. However, interference cancellation may decrease the energy of the SOI signal in the process of decreasing the amount of interference energy.

Prior art CDMA receivers typically scale a received signal at the receiver front-end to exploit the dynamic range of the bits used in quantizing the signal for subsequent processing. This front-end scaling is performed, among other reasons, to avoid division operations in SNR calculations and to exploit the dynamic range of signal quantization in the receiver.

### SUMMARY OF THE INVENTION

Systems and methods for adjusting amplitude of an interference-canceled signal are presented. In one embodiment, a gain controller scales the signal amplitude of an interference-canceled signal. As used herein, an interference-canceled signal is a signal having one or more selected interfering channels and/or signal paths substantially removed from a received signal y. An interference-canceled signal from a Coded Signal Processing Engine (“CSPE”), as used herein, is generally referred to as an output canceled signal.

The received signal y essentially comprises the energy of the selected signal path E_{c} plus all other interference energy Iᵢₙₜ. This total signal energy value I₀ can be used to determine the SNR of an SOI, which is essentially E_{c}/I₀. Accordingly, as the energy of the interference within I₀ decreases and the energy of the SOI remains the same, the SNR of the SOI increases.

Interference cancellation selectively improves the SNR of an SOI by decreasing the energy of certain interfering signals. For example, as the number of interfering signals contributing to the interfering energy Iᵢₙₜ substantially decreases, the SNR of the SOI typically increases because Iᵢₙₜ is a component of I₀ (e.g., if I₀ decreases and E_{c} remains essentially the same, E_{c}/I₀ increases). In selectively canceling certain interfering signals, the signal cancellation decreases the overall energy of the received signal because the energy of interfering signals is substantially removed. Moreover, signal cancellation may cancel energy from the SOI and thus decrease E_{c} by an amount less than the decrease in the energy of the interfering signals.

In a preferred embodiment, therefore, the gain controller comprises a scaling element that scales the overall signal energy, or amplitude, after interference cancellation and prior to signal demodulation in receiver circuitry. This scaling effectively compensates for the overall signal energy reduction resulting from interference cancellation to a level substantially equivalent to the I₀ value prior to cancellation. If the reduction in I₀ energy is greater than the E_{c} energy reduction, the SNR of the SOI as seen by the receiver increases. The amplitude adjusted output canceled signal improves receiver performance as the SOI is demodulated. Since prior art receivers typically adjust signal amplitude at the front-end of the receiver, a gain controller may be used to adjust the amplitude of an interference-canceled signal to a level comparable with that of the prior art front-end scaling. Receiver front-ends comprising signal scaling are well known to those skilled in the art.

The gain controller also comprises a receiving element configured for receiving either an output canceled signal or an uncanceled received signal y as an input. For example, the gain controller may receive an interference-canceled signal output from a CSPE, such as those described in the '360, '828, '777 and TCOM0020 applications. Alternatively, the gain controller may receive the signal y with no interfering components removed. Such an instance may occur when a determination is made to not perform signal cancellation on a symbol via the CSPE. Accordingly, the gain controller may apply a gain of unity (i.e., a gain of one) since there is no decrease in total signal energy attributable to signal cancellation.

In the preferred embodiment, the gain controller is an Automatic Gain Control (“AGC”) that is communicatively coupled between a CSPE and one or more processing fingers of a receiver to selectively adjust the amplitude of the output canceled signal by applying a gain. The AGC may be configured for receiving a bypass signal that alerts the AGC as to whether the CSPE is performing or not performing signal cancellation. Once the bypass signal is received, the AGC may route the received signal through another “gain path” of the AGC. This gain path may apply a gain that is substantially a unity gain. The AGC may be used in a serial canceller embodiment, a parallel canceller embodiment or any combination thereof.

### BRIEF DESCRIPTIONS OF THE DRAWINGS

FIG. 1 is a block diagram of a gain controller in one exemplary embodiment of the invention.

FIG. 2 is a block diagram of another gain controller in one exemplary embodiment of the invention.

FIG. 3 is a block diagram of a gain controller implemented in conjunction with an interference cancellation system in one exemplary embodiment of the invention.

FIG. 4 is a block diagram of a plurality of gain controllers configured with a CSPE in one exemplary embodiment of the invention.

FIG. 5 is a block diagram of a gain controller implemented with a CSPE and a receiver in one exemplary embodiment of the invention.

FIG. 6 is a gain control flow chart in one exemplary methodical embodiment of the invention.

### DETAILED DESCRIPTIONS OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

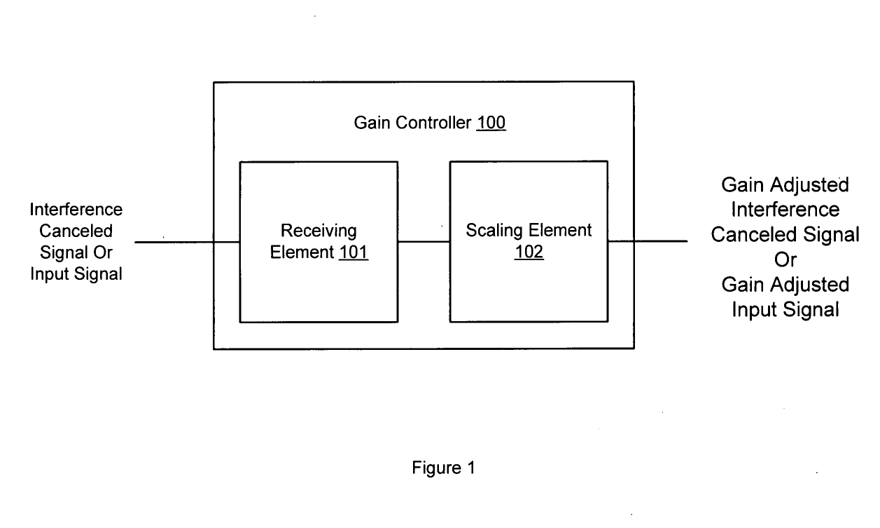

FIG. 1 is a block diagram of gain controller 100 in one exemplary embodiment of the invention. Gain controller 100 is configured for adjusting amplitude of either an interference-canceled signal or an uncanceled input signal. In one embodiment, gain controller 100 comprises receiving element 101 configured for receiving the interference-canceled signal or the input signal. For example, receiving element 101 may be coupled to receive a signal from a CSPE or configured within a CSPE.

The signal from the CSPE may be either an output canceled signal or a received signal in which no cancellation has been performed, such as when the CSPE generates an empty interference matrix that results in no cancellation. An output cancelled signal as used herein is a signal with one or more interfering signals substantially canceled and may be either a signal y having signal cancellation performed thereon or reference code x having signal cancellation performed thereon.

Gain controller 100 also comprises scaling element 102 communicatively coupled to receiving element 101. Scaling element 102 is configured for adjusting amplitude of the received signal from the receiving element 101. For example, if receiving element 101 transfers an output canceled signal to scaling element 102, the scaling element may adjust the amplitude of the signal to a level that is substantially comparable to the level of the signal prior to signal cancellation. If, however, the receiving element transfers an uncanceled signal, scaling element 102 may apply a gain that is substantially a unity gain.

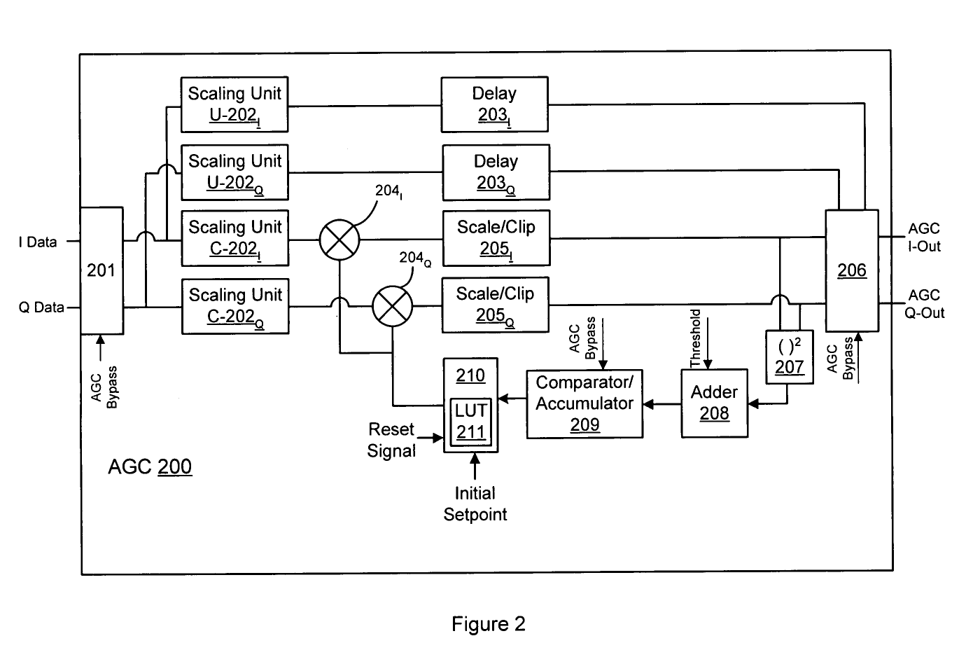

FIG. 2 is a block diagram of gain controller 200 in one exemplary embodiment of the invention. In this embodiment, gain controller 200 is an AGC. Gain controller 200 comprises receiving element 201 for receiving a digital input signal. The input signal may be either an output canceled signal or an uncanceled signal. The receiving element is configured for receiving I (“In-Phase”) and Q (“Quadrature”) components of a CDMA signal.

Gain controller 200 also comprises scaling units 202 configured for adjusting amplitude of the I and Q input signals. The scaling elements in this embodiment are coupled to the receiving element 201 and are established in pairs in order to scale the magnitude of the I and Q components of the received digital input signal. These scaling units 202 scale a digital input signal (e.g., bit shifting the representation of the signal). For example, scaling units 202 may receive digital input signals, wherein a specified number of bits are used to represent the signal. The scaling units 202 may shift and/or truncate the number of incoming bits to decrease the number of bits representing the digital input signal and effectively scale the signal. Such truncation and scaling is a matter of design choice based on the requirements of a device coupled thereto (e.g., if a CSPE uses larger bit widths than the bit widths used by the communicatively coupled receiver). Bit widths and bit shifting are known to those skilled in the art.

A first pair of scaling units 202 (labeled scaling units U-202_{I} and U-202_{Q}) are configured as part of an uncanceled signal path for scaling the I and Q components of a received uncanceled signal. These scaling units 202 may apply a unity gain to the received signal components as signal cancellation was not performed on the signal. Alternatively, the scaling units U-202_{I} and U-202_{Q} may adjust the number of bits in order to match the requirements of a receiver coupled therewith. Scaling units U-202_{I} and U-202_{Q} transfer the signal components to delay elements 203, which substantially delay the signal components, if required, by an amount substantially equivalent to the delay introduced by the interference canceled signal path.

A second pair of scaling units 202 (labeled scaling units C-202_{I} and C-202_{Q}) are configured as part of an interference canceled signal path for scaling the I and Q components of a received interference-canceled signal (i.e., an output canceled signal). In this embodiment, scaling units C-202_{I} and C-202_{Q} are communicatively coupled to an AGC control loop described below herein. The scaling units C-202_{I} and C-202_{Q} apply a gain that is substantially unity or greater. In one embodiment, the scaling units may also adjust the number of bits representing the signal to appropriately scale the signal to an appropriate bit width as specified by the AGC loop.

Once an interference-canceled signal is scaled by scaling units C-202_{I} and C-202_{Q}, the I and Q components of the signal are transferred to multipliers 204_{I} and 204_{Q}. The multipliers 204_{I} and 204_{Q} multiply the signal with a feedback gain provided by the AGC loop lookup table (“LUT”) 211. The multipliers 204_{I} and 204_{Q} transfer the feedback-multiplied signals to scaling/clipping units 205_{I} and 205_{Q} to adjust the amplitude of the signal components and provide output signals that occupy an appropriate number of bits. In one embodiment, scaling/clipping units 205_{I} and 205_{Q} restore the amplitude of the signal components to substantially a level previously attained by front-end scaling in a receiver. Scaling/clipping units 205_{I} and 205_{Q} may adjust the number of bits representing the signal by truncating or rounding the number of bits as described above herein.

With the I and Q components of the signal scaled (i.e., either the scaled interference canceled signal I and Q components or the scaled uncanceled signal I and Q components), the scaled signal components are transferred to selector 206 for transfer to a device coupled thereto. For example, selector 206 is configured for selectively transferring either the scaled I and Q components of the interference-canceled signal or the scaled I and Q components of the uncanceled signal to a receiver for subsequent processing (e.g., tracking and/or demodulation). The selector 206 may select the scaled signal components for transfer based on an AGC bypass signal. For example, an AGC bypass signal may instruct selector 206 to transfer the amplitude adjusted uncanceled signal rather than the amplitude adjusted canceled signal.

Since scaling units C-202_{I} and C-202_{Q} and U-202_{I} and U-202_{Q} are communicatively coupled to receiving element 201, the scaling units may scale whichever signal is received by AGC 200. A determination may be made regarding the signal type that is actually received (i.e., either the I and Q components of the interference-canceled signal or the I and Q components of the uncanceled signal). This determination may be made either within gain controller 200 or by control circuitry external to the gain controller. For example, receiving element 201 may be configured for receiving the bypass signal and, in response to receiving that bypass signal, receiving element 201 may select the I and Q components of either the interference-canceled signal or the uncanceled signal or transmit the I and Q components to the appropriate scaling unit 202.

Such a determination may be based, at least in part, on the amplitude of the signal being transferred to gain controller 200. As stated hereinabove, while improving the actual SNR of a selected signal, interference cancellation may decrease the overall signal energy of a received signal. Accordingly, an interference-canceled signal may not demonstrate the SNR improvement in the receiver unless the signal is appropriately scaled to adjust for the reduction of total energy. Selector 206, therefore, determines which scaled I and Q components are to be transferred in response to receiving the AGC bypass signal. For example, if the AGC bypass signal indicates that a signal received by receiving element 201 is an uncanceled signal, selector 206 may selectively transfer the scaled I and Q components from scaling units U-202_{I} and U-202_{Q} via delay elements 203 to the device coupled thereto. If, however, the AGC bypass signal indicates that the received signal is a canceled signal, selector 206 may selectively transfer the scaled I and Q components from scaling/clipping units 205_{I} and 205_{Q} to the device coupled thereto.

As stated, C-202_{I} and C-202_{Q} are part of a control loop that provides a feedback gain for the interference-canceled signal. This control loop comprises signal squared magnitude unit 207, adder unit 208, comparator/accumulator 209, storage unit 210 (e.g., software, hardware or firmware memory) and LUT 211. Squaring unit 207 is configured for receiving the scaled I and Q components from scaling/clipping units 205_{I} and 205_{Q} and for element-wise squaring of each of the components. The squared components are then transferred to adder unit 208 for summing squared I components with squared Q components over a specified number of elements (e.g., a symbol period). The combination of squaring unit 207 and adder 208 essentially generates an estimate of the average output power of the interference-canceled signal via squaring and summing I and Q components.

In one embodiment, adder unit 208 is configured for summing squared I and Q values, thereby providing summed squared values. Adder 208 subsequently sums those values over a predetermined length. Adder 208 is also configured for receiving a threshold value, which is subtracted from the values summed over the predetermined length. The resulting value from adder 208 is transferred to comparator/accumulator 209 for determining whether energy of the scaled interference-canceled signal is greater than or less than the threshold. Effectively, the signal comparison is performed about the value of zero to thereby determine sign of the signal. In an alternative embodiment, the comparator/accumulator 209 may receive the threshold signal and the comparison may be against the threshold value. As the energy of the scaled interference-canceled signal changes, in either embodiment, a comparator/accumulator 209 either increments or decrements an index count in the accumulator based on the energy of the scaled interference-canceled signal as compared to a threshold.

In one preferred embodiment, if the amplitude of the scaled interference-canceled signal is less than the threshold, comparator/accumulator 209 increments the index count. If the amplitude of the scaled interference-canceled signal is greater than the threshold, comparator/accumulator 209 decrements the index count. The index counter ranges from 0 to N, whereby the accumulator is saturated at the range end values (i.e., either 0 or N). Therefore, the accumulator does not decrement a value of 0 or increment a value of N. For example, for a greater value of the index there is a greater amount of scaling (e.g., feedback gain).

The index count from comparator/accumulator 209 may be used as an index into LUT 211 configured within storage unit 210. In the preferred embodiment, there are N+1 possible gain values stored within LUT 211 in which the index count of comparator/accumulator 209 can access. The gain values may provide gains either on a linear or nonlinear scale based on index counts (e.g., gain values may be in ¼ dB increments on a linear scale). Once the gain of LUT 211 is accessed, the I and Q components of the interference-canceled signal are multiplied by the gain value via multipliers 204_{I} and 204_{Q}, respectively. These gain values when applied to the I and Q components of the interference-canceled signal dynamically adjust the amplitude of the interference-canceled signal.

While the count value from comparator/accumulator 209 is useful in indexing a particular gain value for application to the interference-canceled signal, this count value may also be used to retrieve a previous gain value of the interference-canceled signal if the gain value is frozen and stored in an AGC bypass situation. For example, once an AGC bypass signal is received, the control loop comprising elements 205_{I}, 205_{Q}, 207, 208, 209, 210 and 211 stores a gain value of the interference-canceled signal in storage unit 210 because signal cancellation has halted. When signal cancellation restarts and the AGC bypass signal has changed, the control loop may retrieve the previously stored gain value from storage unit 210 to begin scaling the amplitude of the interference-canceled signal from the previous gain value. Accordingly, the stored gain value may decrease the amount of time for the gain controller 200 to converge to an appropriate gain value for the interference-canceled signal. Those skilled in the art should readily recognize that the gain value required for scaling a symbol of the interference cancelled signal to a level substantially equivalent to a level provided by the front end of a receiver may change on a symbol by symbol basis.

Additionally, the storage unit 210 may be configured to receive a reset signal to delete a stored gain value if the AGC is reset. For example, it may be necessary to reset the AGC when an input signal changes. If an input signal changes, such as when a CSPE selects another signal to cancel interference from and thereby changes the output cancelled signal, the reset signal may be generated and transferred to reset the AGC so that the AGC does not restore the new input signal to a gain value of the previous input signal. In receiving the reset signal, the AGC resets the count value to an initial setpoint that indexes a predetermined initial gain value. In one embodiment, the initial setpoint may be set to zero, so that the initial gain value is unity. In a second embodiment, the initial setpoint value may be based on the strengths of interfering signals within processing fingers. For example, low energy interference signals may have a low initial setpoint and high energy interference signals may have a high initial setpoint. Sets of interference energy values may have the same initial setpoint. In a third embodiment, the initial setpoint value may be an arbitrary non-zero value. Selecting an appropriate setpoint may reduce the time of convergence for the AGC.

While one embodiment has been shown and described herein, those skilled in the art should readily recognize that other embodiments may fall within the scope and spirit of the invention. For example, gain controller 200 illustrates one preferred implementation that is particularly useful in adjusting amplitude of an interference-canceled signal and recovering stored gain values via the control loop as described herein. Furthermore, the preferred implementation of gain controller 200 is not intended to limit the invention to the gain control of an AGC. Rather, other types of gain control may be used and are simply a matter of design choice.

Present embodiments of the AGC may be implemented within an Application Specific Integrated Circuit (“ASIC”), Field Programmable Gate Array (“FPGA”), Digital Signal Processor (“DSP”) and/or other circuitry. However, the invention is not intended to be limited to such implementations as the embodiments may be implemented in hardware, software, firmware, optics or any combination thereof. For at least these reasons, the invention should not be limited to the preferred embodiment shown and described herein. Rather, the invention should only be limited by the language recited in the claims and their equivalents.

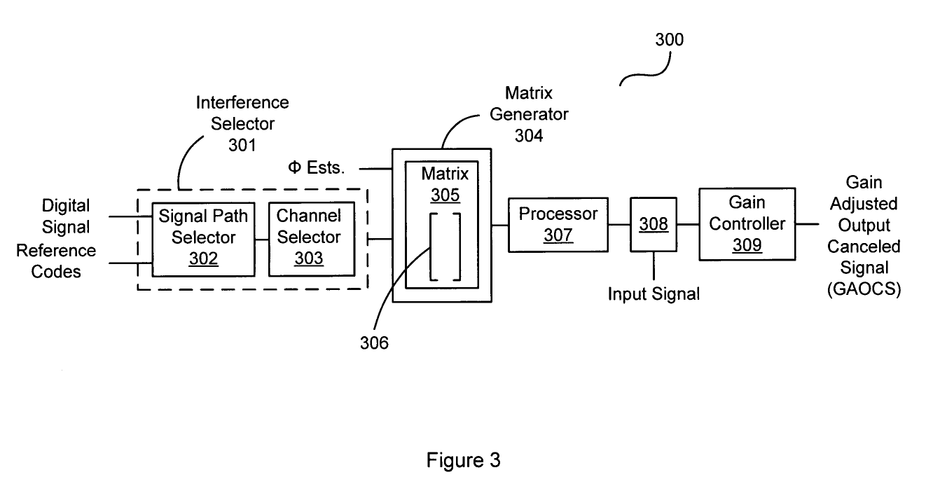

FIG. 3 is a block diagram 300 of gain controller 309 implemented in conjunction with an interference cancellation system (i.e., element 301 comprising elements 302 and 303; and elements 304, 305, 306, 307 and 308) in one exemplary embodiment of the invention. In this embodiment, gain controller 309 is configured to receive a digital signal from the interference cancellation system and to adjust the amplitude of a digital signal in a manner similar to that described in FIG. 2. For example, the interference cancellation system may output either an interference-canceled signal or an uncanceled signal from applicator 308. Gain controller 309 may be used to scale the output canceled signal to a level substantially similar to the level of the signal after front-end scaling by a receiver.

In this embodiment, the interference cancellation system is illustrated comprising an interference selector 301 for selecting one or more interfering signals from a received digital signal. Interference selector 301 may also receive reference codes corresponding to those interfering signals for use in selecting those interfering signals. For example, interference selector 301 may comprise signal path selector 302 and channel selector 303 for selecting certain interfering signal path and channel combinations based on on-time PN reference codes of a received signal path and covering codes of associated channels.

The selected interfering signal paths and/or channel combinations are transferred to matrix generator 304 for generating interference matrix 305, which is used to substantially cancel, or remove, the selected interferers from the digital signal. For example, as described in the TCOM0020 application, interfering signal paths, associated channels and/or the various combinations thereof may be input to matrix 305 as one or more interference vectors 306. Additionally, phase estimates of the signal paths and their associated channels may also be transferred to matrix generator 305 for imposition of phase on the interference vectors 306. Processor 307 may use interference matrix 305 to generate a cancellation operator that is subsequently applied to an input signal via applicator 308. The input signal may be a received digital signal, an output canceled signal, a reference code or an output canceled reference code, such as those described in the '777, '345, TCOM0020, and '828 applications. In one embodiment, one or more of the interference vectors 306 may comprise composite interference vectors as described in the '360 and TCOM0020 applications.

In one embodiment, the cancellation operator is a projection operator that projects an input signal onto a subspace that is substantially orthogonal to a subspace spanned by the selected interfering signals. Such a projection operator may be generated by processor 307 according to the following form:
Pₛ^{⊥}=I−S(S^{T}S)⁻¹S^{T} (Eq. 1)
wherein Pₛ^{⊥} is the projection operator, I is an identity matrix, S is an interference matrix 305 and S^{T} is a transpose of the matrix 305. Projection operators and their associated constructions are described in the '346, '360, '829, '219 and '834 applications.

Although described and illustrated in one preferred embodiment, those skilled in the art should readily recognized that gain controller 309 may be configured in a variety of ways to receive an output canceled signal and/or an uncanceled signal and thereby control the amplitude of that received signal. Accordingly, the invention is not intended to be limited to the embodiment shown and described herein; rather, the invention is only intended to be limited by the language recited in claims and their equivalents.

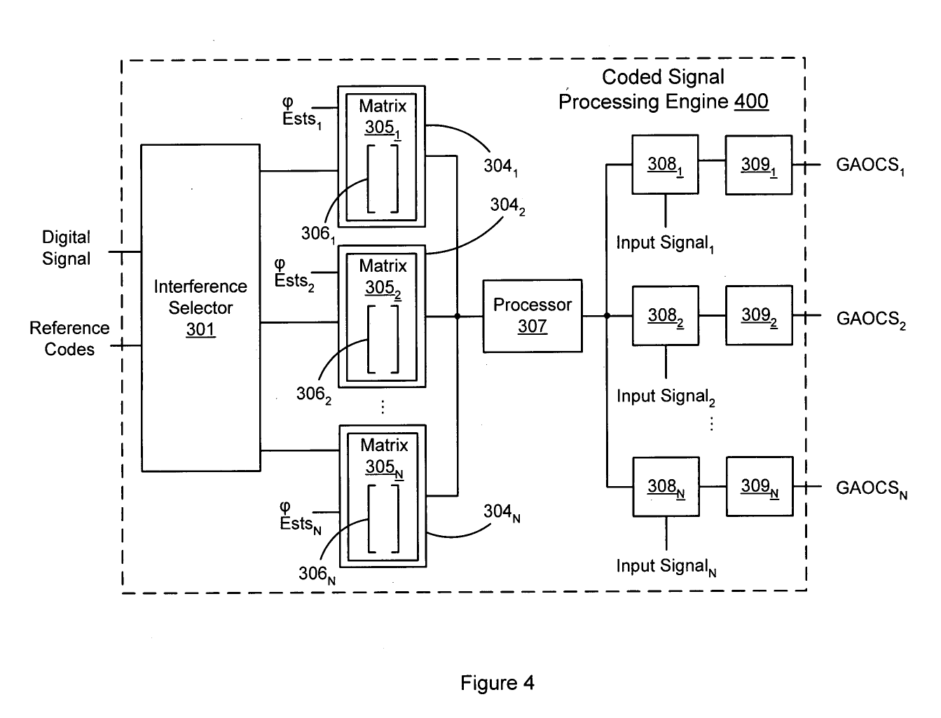

FIG. 4 is a block diagram of a plurality of gain controllers 309 configured within CSPE 400 in one exemplary embodiment of the invention. In this embodiment, CSPE 400 comprises an interference selector 301 and a plurality of matrix generators 304 (labeled 304₁, . . . , 304_{N}), such as those shown and described in FIG. 3. Interference selector 301 selectively transfers certain interfering signal paths and channels to matrix generators 304 as vectors (e.g., 306₁, . . . , 306_{N}) for matrices 305 (labeled 305₁, . . . , 305_{N}, wherein N is an integer greater than one). Each matrix 305 may be composed of a plurality of vectors 306. As in FIG. 3, matrix generators 304 may receive phase estimates of the interfering signal paths for imposition of phase on the interference vectors 306 as well as additional bit (e.g., sign) information and/or amplitude scaling terms.

Processor 307 may use these matrices 305 to generate a plurality of cancellation operators (e.g., such as the cancellation operator described in FIG. 3). Once the cancellation operators are generated, processor 307 transfers the cancellation operators to applicators 308 for application to various input signals (labeled input signal, . . . , input signal_{M}). Each input signal may comprise any of a received digital signal, an output canceled signal, an on time PN reference code or an output canceled on time PN reference code.

Each applicator 308 may apply a cancellation operator to an input signal to generate a unique output signal. The output signal may be either an output canceled signal or an uncanceled signal, wherein the latter is based on the generation of an empty matrix 305 or a pass-through of an uncanceled signal. For example, a matrix 305 of selected interfering signals represented by vectors 306 may be used to generate a cancellation operator which substantially cancels those selected interfering signals from the input signal. Alternatively, a matrix 305 may contain no interfering signals (e.g., an empty matrix), which results in the generation of a cancellation operator that is a scalar of one and no signals are, therefore, canceled from the input signal. An empty matrix 305, therefore, results in an uncanceled output signal. Control determinations for either selecting or not selecting certain interfering signals for matrix generation may be performed within CSPE 400, an external controller or directed by a receiver communicatively coupled thereto.

Each signal from applicators 308 is subsequently transferred to a corresponding gain controller 309 (labeled 309₁, . . . , 309_{M}). The gain controller 309 applies a gain to the received signal based on the type of signal received and its energy. For example, if the signal is an output canceled signal, the gain controller 309 may apply a gain greater than or equal to one to the signal, as shown and described in FIG. 2, that restores the power of the signal to a level substantially comparable to the level produced by front-end scaling by a receiver. Alternatively, if the received signal has no interference cancellation performed thereon, the gain controller 309 may apply a unity gain to the signal. The gain controllers 309 subsequently provide a plurality of amplitude adjusted output canceled signals (labeled GAOCS₁, . . . , GAOCS_{M}). In one embodiment matrix generators 304 may transfer a bypass signal to the gain controllers 309 that specifies whether the signal is a canceled signal or an uncanceled signal.

While described and illustrated in one preferred embodiment, those skilled in the art should readily recognized that the embodiment is only exemplary in nature and that other embodiments may fall within the scope and spirit of the invention. Accordingly, the invention is not intended to be limited to the embodiment shown and described herein; rather, the invention is only intended to be limited by the language recited in claims and their equivalents. Moreover, those skilled in the art should readily recognize that this embodiment may be implemented for serial interference cancellation or for parallel interference cancellation as described in the '777, '836, TCOM0019 and TCOM0024 applications.

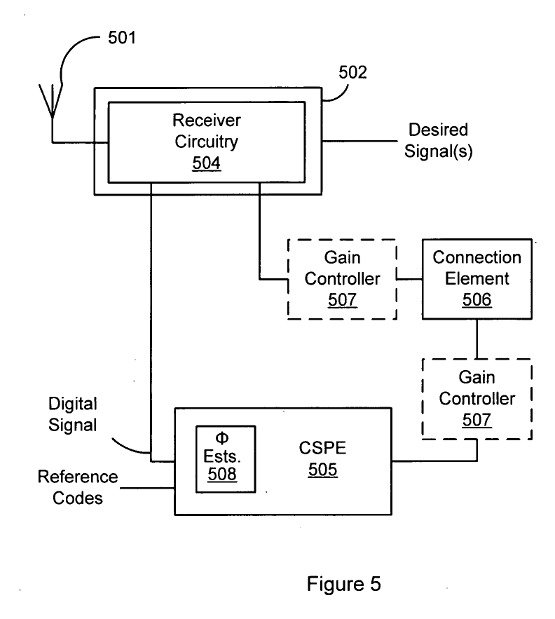

FIG. 5 is a block diagram of gain controller 507 implemented with CSPE 505 and receiver 502 in one exemplary embodiment of the invention. In this embodiment, receiver 502 receives an RF analog signal via antenna 501 and down-converts and quantizes the analog signal into a digital baseband signal using receiver circuitry 504. In quantizing the analog signal, receiver circuitry 504 may perform a front-end scaling of the signal to exploit the dynamic range of available bits for subsequent processing and scaling the signal such that the total received energy is substantially equal to a specified value.

Digital receiver circuitry 504 transfers the digital signal to CSPE 505 for selective cancellation of certain signal paths and channels that interfere with an SOI within the digital signal. Such interference cancellation may be performed in accordance with the embodiments shown and described in FIGS. 3 and 4. For example, CSPE 505 may construct one or more interference matrices from components, such as reference codes, covering codes, phase estimates (labeled φ Ests. 508), symbol sign values and/or amplitudes of selected interfering signals. CSPE 505 may subsequently generate one or more cancellation operators from the one or more interference matrices. CSPE 505 may therefore apply the one or more cancellation operators to one or more input signals for selective cancellation of interfering signals from those input signals.

From these one or more interference cancellations, CSPE 505 may generate one or more output canceled signals for use by receiver 502. For example, receiver circuitry 504 may comprise one or more processing fingers which track and/or demodulate the transferred output canceled signals from CSPE 505. A connection element 506 is configured between receiver circuitry 504 and CSPE 505 to selectively transfer the one or more output signals and possibly other signals from CSPE 505 to receiver circuitry 504 for subsequent processing.

In this embodiment, gain controller 507 is configured external to CSPE 505. The gain controller 507 may be optionally configured between receiver circuitry 504 and connection element 506 or between connection element 506 and CSPE 505. In either configuration, gain controller 507 may represent a plurality of gain controllers, each configured for restoring the power of a received signal to a substantially similar level to what was produced by front-end scaling by receiver circuitry 504. For example, as CSPE 505 may decrease the overall signal power of a received digital signal, albeit while improving SNR of an SOI within the digital signal, a gain controller 507 may adjust the amplitude of an output canceled signal from CSPE 505 to compensate for any associated decrease in total energy of the signal. Amplitude adjustments of gain controller 507 may be performed in accordance with the embodiment shown and described in FIG. 2 While this implementation shows how a gain controller, such as gain controller 507, may be configured between the CSPE and a receiver 502, the invention is not intended to be limited to the implementation shown and described herein. Those skilled in the art should readily recognize that gain controller 507 may be configured in other ways which fall within the scope and spirit of the invention. For example, gain controller 507 may be configured within receiver circuitry 504 for applying a gain to the one or more received signals from a CSPE. Alternatively, gain controller 507 may be configured within the CSPE. The invention, therefore, is only intended to be limited by the language recited in the claims and their equivalents.

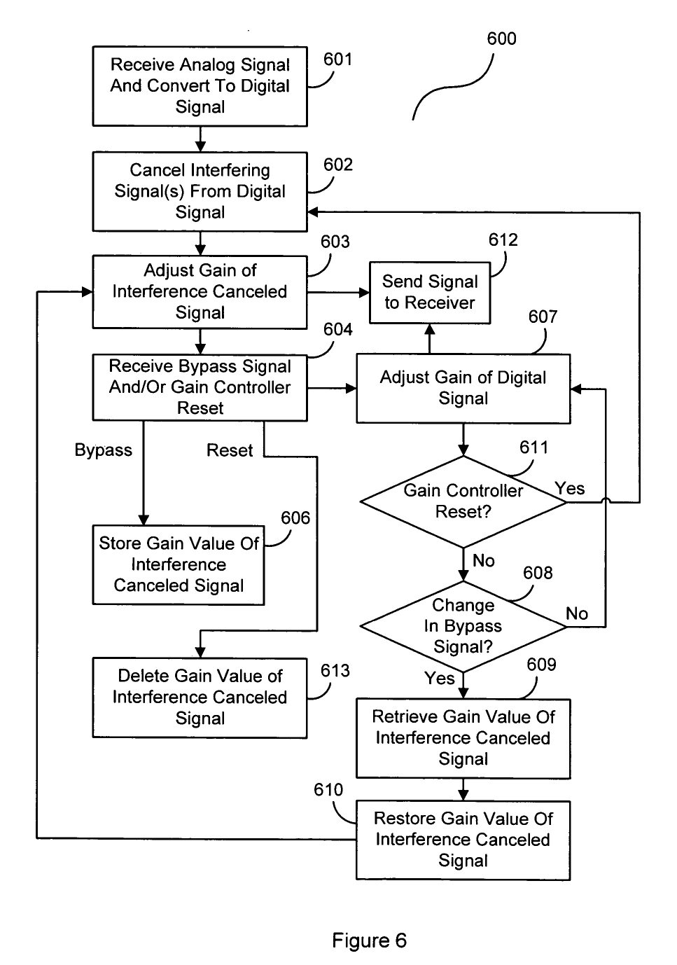

FIG. 6 is gain control flow chart 600 in one exemplary methodical embodiment of the invention. In this embodiment, an analog signal is received and converted to a digital representation of the signal, in element 601. For example, a receiver such as receiver 502 of FIG. 5 may receive an RF analog signal and down-convert, quantize and scale that signal producing a digital baseband signal using a down-converter, an analog to digital (“A/D”) converter and an AGC. Down-converters, A/D converters and AGCs are well-known to those skilled in the art.

The digital signal may comprise one or more interfering signals as well as an SOI. Signal cancellation may be performed on the digital signal to substantially cancel the one or more interfering signals from the digital signal, in element 602, and thereby generate an interference-canceled signal. Such signal cancellation may be performed by a CSPE, such as CSPE 400 of FIG. 4.

The energy of the interference-canceled signal is amplitude adjusted, in element 603. For example, a gain controller, such as gain controller 200 of FIG. 2, may apply a gain to the interference-canceled signal to substantially restore the total signal energy to a level substantially similar to the level after front-end scaling by a receiver. The amplitude-adjusted signal may then be transferred to a receiver for processing, in element 612. If interference cancellation upon the signal temporarily ceases, a bypass signal may be generated in order to bypass gain adjustment of the interference-canceled signal. Accordingly, a bypass signal indicating that the received signal is an uncancelled signal is received, in element 604, and the gain value of the interference-canceled signal is stored, in element 606. Alternatively, if a reset signal is received in element 604, the gain value of the interference-canceled signal and/or the stored gain value of the uncancelled signal is deleted, in element 613.

Additionally, the bypass signal causes the amplitude adjustment of the received digital signal to be returned to unity, in element 607. For example, interference cancellation by a CSPE may be temporarily halted through the construction of an empty matrix and subsequent application of an associated scalar of one to the received signal. Accordingly, amplitude adjustment of the interference-canceled signal may be bypassed in favor of amplitude adjustment of the uncanceled signal in accordance with the embodiment shown and described in FIG. 2. As with the interference cancelled signal, the amplitude adjusted uncanceled signal may be subsequently transferred to a receiver for processing, in element 612.

Once the bypass signal is received in element 604, amplitude adjustment is performed in element 607 on the uncanceled digital signal until a gain controller reset or a change in the bypass signal is detected, in elements 607 and 608 respectively. A gain controller reset may be produced if a different signal path is sent to a matrix generator and/or a different input signal is transferred to the gain applicator. If a gain controller reset is received (i.e., element 611) then the saved gain value is deleted and the process continues to element 602. Otherwise, the process continues to element 608. In an alternative embodiment, elements 608 and 611 are exchanged in the method. If no change in the bypass signal is detected, the amplitude adjustment of the uncanceled digital signal of element 607 continues. Once a change is detected in the bypass signal, amplitude adjustment reverts to the gain value corresponding to the interference-canceled signal.

Amplitude adjustment of the interference-canceled signal is restored by retrieving a previous gain value of the interference-canceled signal if the bypass signal is received, in element 609, or reverting to an initial value if the reset signal is received, in element 613. The initial value may be fixed or based upon the strength of the interfering signal. For example, the previous gain value may be retrieved from storage unit 210 and/or LUT 211 of FIG. 2. The previous gain value may be used to scale the interference-canceled signal to restore the energy of the interference-canceled signal to an amount substantially equivalent to that observed prior to receiving the bypass signal, in element 610. Once restored, amplitude adjustment of the interference-canceled signal continues in element 603 until another change in the bypass or reset signal is received.

While one preferred embodiment has been shown and described herein, those skilled in the art should readily recognize that the invention is not intended to be limited to the preferred embodiment. Rather, the invention is only intended to be limited by the language recited in the claims. Additionally, while the invention has been illustrated and described in detail in the drawings and foregoing description, such illustration and description is to be considered as exemplary and not restrictive in character. Accordingly, it should be understood that only the preferred embodiment and minor variants thereof have been shown and described and that all changes and modifications that come within the spirit of the invention are desired to be protected.

1. A system, comprising:
a processing engine configured for substantially canceling one or more interfering signals from an input signal to generate an interference-canceled signal; and
a gain controller configured for receiving the interference-canceled signal, the interference-canceled signal having an amplitude and for amplitude adjusting the interference-canceled signal for producing an amplitude adjusted interference-canceled signal.

2. The system of claim 1, wherein the gain controller is an automatic gain control.

3. The system of claim 1, wherein the gain controller is configured for amplitude adjusting the interference-canceled signal to a predetermined amplitude value.

4. The system of claim 1, wherein the gain controller comprises a receiving element configured for receiving either the input signal or the interference-canceled signal.

5. The system of claim 4, wherein the gain controller is further configured for amplitude adjusting the input signal for producing an amplitude adjusted input signal upon receiving the input signal.

6. The system of claim 5, wherein the gain controller comprises a selector configured for selecting either the amplitude adjusted input signal or the amplitude adjusted interference-canceled signal.

7. The system of claim 6, configurable with a receiver to provide either the amplitude adjusted input signal or the amplitude adjusted interference-canceled signal to the receiver.

8. The system of claim 6, wherein the gain controller comprises memory configured for storing a previous gain value of the amplitude adjusted interference-canceled signal.

9. The system of claim 8, further comprising a memory location used to store the previous gain value of a lookup table.

10. The system of claim 8, wherein the gain controller comprises a comparator configured for receiving a bypass signal used by the comparator to retrieve the previous gain value.

11. The system of claim 10, wherein the gain controller is further configured for restoring the amplitude of the interference-canceled signal to substantially a previous amplitude in response to a change in the bypass signal.

12. The system of claim 8, wherein the gain controller comprises a selector configured for receiving a bypass signal used by the selector to specify whether the amplitude adjusted interference-canceled signal or the amplitude adjusted input signal is transferred to the receiver.

13. The system of claim 8, wherein the gain controller comprises a comparator configured for receiving a reset signal used by the comparator for deleting the previous gain value.

14. The system of claim 13, wherein the reset signal used by the comparator is configured to specify an initial value.

15. The system of claim 14, wherein the initial value is a fixed value.

16. The system of claim 14, wherein the initial value is determined from energy of an interfering signal.

17. A gain controller, comprising:
a receiving element configured for receiving either an interference-canceled signal or an input signal; and
a scaling element configured for amplitude adjusting either a received said interference-canceled signal or a received said input signal based on a characteristic of the received said interference-canceled signal or the received said input signal.

18. The gain controller of claim 17, wherein the scaling element is configured as an automatic gain controller.

19. The gain controller of claim 17, wherein the amplitude of the received said interference-canceled signal or the received said input signal is adjusted to a predetermined value to provide either an amplitude adjusted said input signal or an amplitude adjusted said interference-canceled signal.

20. The gain controller of claim 19, wherein the predetermined value is determined by front-end circuitry of a receiver.

21. The gain controller of claim 19, wherein the scaling element comprises a selector configured for selecting the amplitude adjusted said input signal or the amplitude adjusted said interference-canceled signal.

22. The gain controller of claim 21, wherein the gain controller is configurable with a receiver and wherein the selector is further configured to provide either the amplitude adjusted said input signal or the amplitude adjusted said interference-canceled signal to the receiver.

23. The gain controller of claim 19, wherein the scaling element comprises memory configured for storing a previous gain value of the amplitude adjusted said interference-canceled signal.

24. The gain controller of claim 23, wherein the scaling element comprises a comparator configured for receiving a bypass signal used by the comparator to retrieve the previous gain value.

25. The gain controller of claim 24, wherein the scaling element is further configured for substantially restoring the amplitude of the interference-canceled signal by applying the previous gain value in response to a change in the bypass signal.

26. The gain controller of claim 23, wherein the scaling element comprises a comparator configured for receiving a reset signal used by the comparator for deleting the previous gain value.

27. The gain controller of claim 26, wherein the reset signal used by the comparator is configured to specify an initial gain value.

28. The gain controller of claim 27, wherein the initial gain value is a fixed value.

29. The gain controller of claim 27, wherein the initial gain value is determined from energy of an interfering signal.

30. The gain controller of claim 17, wherein the scaling element comprises a memory location for storing a previous gain value of a lookup table.

31. The gain controller of claim 19, wherein the scaling element comprises a selector configured for receiving a bypass signal used by the selector to specify whether the amplitude adjusted interference-canceled signal or the amplitude adjusted said input signal is transferred to the receiver.

32. A mobile handset, comprising:
a receiver configured for receiving an analog signal and for converting the analog signal into a digital signal;
a processing engine configured for receiving the digital signal and substantially canceling one or more interfering components of the digital signal to generate an interference-canceled signal; and
a gain controller configured for receiving the interference-canceled signal and for amplitude adjusting the interference-canceled signal to produce an amplitude adjusted interference-canceled signal.

33. The mobile handset of claim 32, wherein the gain controller is an automatic gain control.

34. The mobile handset of claim 32, wherein the gain controller is further configured for amplitude adjusting the interference-canceled signal to a predetermined amplitude value.

35. The mobile handset of claim 32, wherein the gain controller comprises a receiving element configured for receiving either the digital signal or the interference-canceled signal.

36. The mobile handset of claim 35, wherein the gain controller further comprises a selector configured for selecting either an amplitude adjusted digital signal produced from the digital signal or the amplitude adjusted interference-canceled signal for producing either a selected amplitude adjusted digital signal or a selected amplitude adjusted interference-canceled signal.

37. The mobile handset of claim 36, wherein the selector is further configured for receiving a bypass signal used by the selector to select either the amplitude adjusted digital signal or the amplitude adjusted interference-canceled signal.

38. The mobile handset of claim 36, wherein the receiver is further configured for processing the selected amplitude adjusted digital signal or the selected amplitude adjusted interference-canceled signal, and wherein the gain controller is further configured to provide either the selected amplitude adjusted digital signal or the selected amplitude adjusted interference-canceled signal to the receiver.

39. The mobile handset of claim 32, wherein the gain controller comprises memory configured for storing a previous gain value of the amplitude adjusted interference-canceled signal.

40. The mobile handset of claim 39, wherein the gain controller further comprises a memory location for storing a previous gain value of a lookup table.

41. The mobile handset of claim 40, wherein the gain controller comprises a comparator configured for receiving a bypass signal used by the comparator to retrieve the previous gain value.

42. The mobile handset of claim 41, wherein the gain controller is further configured for restoring the gain value of the interference-canceled signal to the previous gain value in response to a change in the bypass signal.

43. The mobile handset of claim 32, wherein the gain controller comprises a selector configured for receiving a bypass signal used by the selector to specify whether the amplitude adjusted interference-canceled signal or the amplitude adjusted digital signal is transferred to the receiver.

44. The mobile handset of claim 32, wherein the gain controller comprises a comparator configured for receiving a reset signal used by the comparator for deleting a previous gain value.

45. The mobile handset of claim 44, wherein the reset signal used by the comparator is configured to specify an initial gain value.

46. The mobile handset of claim 45, wherein the initial gain value is a fixed value.

47. The mobile handset of claim 45, wherein the initial gain value is determined from energy of an interfering signal.

48. A gain controller circuit for use with an interference canceller, comprising:
a receiving element configured for receiving an interference-canceled signal; and
a scaling element configured for amplitude adjusting the interference-canceled signal for producing an amplitude adjusted interference canceled signal.

49. The gain controller circuit of claim 48, wherein the receiving element is further configured for receiving either an input signal or the interference-canceled signal.

50. The gain controller circuit of claim 48, further comprising a selector configured for selecting either an amplitude adjusted input signal or the amplitude adjusted interference-canceled signal as an output signal of the gain controller circuit.

51. The gain controller circuit of claim 50, further configurable with a receiver to provide the output signal to the receiver.

52. A method, comprising:
providing for receiving a first digital signal;
providing for adjusting amplitude of the first digital signal in response to receiving the first digital signal;
providing for receiving a second digital signal; and
providing for bypassing the first digital signal from amplitude adjustment in response to receiving the second digital signal.

53. The method of claim 52, further comprising providing for selecting the first digital signal as an input signal to a receiver in response to adjusting.

54. The method of claim 52, further comprising providing for selecting the second digital signal as an input signal to a receiver in response to bypassing.

55. The method of claim 52, further comprising providing for storing a gain value corresponding to the first digital signal in memory in response to adjusting.

56. The method of claim 52, further comprising providing for receiving a bypass signal, wherein the bypass signal is used to initiate bypassing the first digital signal.

57. The method of claim 56, further comprising providing for bypassing the second digital signal in response to a change in the bypass signal.

58. The method of claim 57, further comprising providing for retrieving a previous gain value of the first digital signal from memory in response to bypassing the second digital signal.

59. The method of claim 58, further comprising providing for multiplying the first digital signal by a restored said previous gain value in response to retrieving.

60. The method of claim 58, further comprising providing for deleting the previous gain value in response to receiving a reset signal.

61. The method of claim 60, further comprising providing for configuring the reset signal used by the comparator to specify an initial gain value.

62. The method of claim 61, wherein the initial gain value is a fixed value.

63. The method of claim 61, wherein the initial gain value is determined from energy of an interfering signal.

64. A method, comprising:
providing for receiving an analog signal;
providing for converting the analog signal into a digital signal;
providing for substantially canceling one or more interfering components from the digital signal to generate an interference-canceled signal;
providing for adjusting amplitude of the interference-canceled signal in response to substantially canceling the one or more interfering components to generate an amplitude adjusted interference-canceled signal.

65. The method of claim 64, further comprising:
providing for receiving a bypass signal; and
providing for interrupting said adjusting in response to receiving the bypass signal.

66. The method of claim 65, further comprising providing for amplitude adjusting the digital signal in response to receiving the bypass signal to generate an amplitude adjusted digital signal.

67. The method of claim 66, further comprising providing for conveying the amplitude adjusted digital signal to a receiver in response to adjusting the amplitude of the digital signal.

68. The method of claim 65, further comprising providing for storing a gain value of the amplitude adjusted said interference-canceled signal in response to receiving the bypass signal.

69. The method of claim 64, further comprising providing for conveying the amplitude adjusted interference-canceled signal to a receiver in response to adjusting the amplitude of the interference-canceled signal.

70. A method, comprising:
providing for receiving either an interference-canceled signal or an input signal for producing either a received interference-canceled signal or a received input signal; and
providing for amplitude adjusting of either the received interference-canceled signal or the received input signal to produce either an amplitude adjusted input signal or an amplitude adjusted interference-canceled signal; and
providing for transferring either of the amplitude adjusted input signal or the amplitude adjusted interference-canceled signal to a receiver.

71. The method of claim 70, wherein said providing for amplitude adjusting comprises providing either the amplitude adjusted input signal or the amplitude adjusted interference-canceled signal with substantially a predetermined amplitude value.

72. The method of claim 70, wherein said providing for amplitude adjusting comprises providing for applying a gain multiplier to either the interference-canceled signal or the input signal.

73. The method of claim 71, further comprising providing for receiving a bypass signal, wherein the bypass signal is used to store a gain value of the amplitude adjusted interference-canceled signal.

74. The method of claim 73, further comprising providing for retrieving a previous gain value of the amplitude adjusted interference-canceled signal in response to a change in the bypass signal.

75. A system, comprising:
means for receiving a first digital signal;
means for amplitude adjustment of the first digital signal in response to receiving the first digital signal;
means for receiving a second digital; and
means for bypassing the first digital signal from amplitude adjustment in response to receiving the second digital signal.

76. The system of claim 75, further comprising means for selecting the first digital signal as an input signal to a receiver in response to amplitude adjustment.

77. The system of claim 75, further comprising means for selecting the second digital signal as an input signal to a receiver in response to bypassing.

78. The system of claim 75, further comprising means for storing a gain value corresponding to the first digital signal in memory in response to amplitude adjustment.

79. The system of claim 75, further comprising means for receiving a bypass signal, wherein the bypass signal is used to initiate bypassing the first digital signal.

80. The system of claim 79, further comprising means for bypassing the second digital signal in response to a change in the bypass signal.

81. The system of claim 80, further comprising means for retrieving a previous gain value of the first digital signal from memory in response to bypassing the second digital signal.

82. The system of claim 81, further comprising means for substantially restoring the first digital signal to substantially the previous amplitude in response to retrieving the previous gain value.

83. The system of claim 82, further comprising means for deleting the previous gain value in response to receiving a reset signal.

84. The system of claim 82, wherein the reset signal used by the comparator is configured to specify an initial gain value.

85. The system of claim 83, wherein the initial gain value is a fixed value.

86. The system of claim 83, wherein the initial gain value is determined from energy of an interfering signal.

87. A system, comprising:
means for receiving an analog signal;
means for converting the analog signal into a digital signal;
means for substantially canceling one or more interfering components from the digital signal to generate an interference-canceled signal;
means for amplitude adjusting the interference-canceled signal in response to substantially canceling the one or more interfering components to generate an amplitude adjusted interference-canceled signal.

88. The system of claim 87, further comprising:
means for receiving a bypass signal; and
means for forgoing said amplitude adjusting in response to receiving the bypass signal.

89. The system of claim 88, further comprising means for amplitude adjusting the digital signal in response to receiving the bypass signal to generate an amplitude adjusted digital signal.

90. The system of claim 89, further comprising means for providing the amplitude adjusted digital signal to a receiver in response to amplitude adjusting the digital signal.

91. The system of claim 88, further comprising means for storing a gain value of the amplitude adjusted interference-canceled signal in response to receiving the bypass signal.

92. The system of claim 87, further comprising means for providing the amplitude adjusted interference-canceled signal to a receiver in response to amplitude adjusting the interference-canceled signal.

93. A system, comprising:
means for receiving either an interference-canceled signal or an input signal to produce either a received interference-canceled signal or a received input signal; and
means for amplitude adjusting either the received interference-canceled signal or the received input signal.

94. The system of claim 93, wherein said means for amplitude adjusting comprises means for amplitude adjusting either the received interference-canceled signal or the received input signal to a predetermined value to provide either an amplitude adjusted input signal or an amplitude adjusted interference-canceled signal.

95. The system of claim 93, wherein said means for amplitude adjusting comprises means for applying a gain multiplier to either the received interference-canceled signal or the received input signal.

96. The system of claim 94, further comprising means for providing either of the amplitude adjusted input signal or the amplitude adjusted interference-canceled signal to a mobile handset receiver.

97. The system of claim 94, further comprising means for receiving a bypass signal, wherein the bypass signal is used to store a gain value of the amplitude adjusted interference-canceled signal.

98. The system of claim 97, further comprising means for retrieving a previous gain value of the amplitude adjusted interference-canceled signal in response to a change in the bypass signal.

99. The system of claim 98, further comprising means for deleting the previous gain value in response to receiving a reset signal.

100. The system of claim 99, wherein the reset signal used by the comparator is configured to specify an initial gain value.

101. The system of claim 100, wherein the initial gain value is a fixed value.

102. The system of claim 100, wherein the initial gain value is determined from energy of an interfering signal.

103. A digital computer system programmed to perform the method of claim 52, 53, 54, 55, 56, 57, 58, 59, 60, 61, 62, 63, 64, 65, 66, 67, 68, 69, 70, 71, 72, 73, or 74.

104. A computer-readable medium storing a computer program implementing the method of claim 52, 53, 54, 55, 56, 57, 58, 59, 60, 61, 62, 63, 64, 65, 66, 67, 68, 69, 70, 71, 72, 73, or 74.
